(19) United States
(12) Patent Application Publication
(10) Pub. No.: US 2022/0289150 A1
(43) Pub. Date: Sep. 15, 2022

(54) Handheld Washing Device

(71) Applicant: Taku Enow, Denver, CO (US)

(72) Inventor: Taku Enow, Denver, CO (US)

(21) Appl. No.: 17/385,114

(22) Filed: Jul. 26, 2021

Related U.S. Application Data
(60) Provisional application No. 63/160,227, filed on Mar. 12, 2021.

(51) Int. Cl. B60S 3/04; A46B 13/04; B05B 7/04; B05B 3/02

(52) U.S. Cl. CPC B60S 3/048; A46B 13/04; B05B 7/0408; B05B 3/02

(57) ABSTRACT

The present invention relates to a handheld portable washing device. The handheld washing device is designed to apply a pressurized soapy solution and water to any surface for washing. The washing device includes an elongated shaft having a hose connector on one end and an interchangeable dispensing nozzle on the opposite end. The hose connector receives a liquid from a hose or other source, wherein the liquid runs through a conduit within the elongated shaft for dispensing. The device has a handle for gripping and includes a built-in battery, motor and control circuit. The portable device provides an adjustable spray device for enabling a user to manually change pressure and the flow of a liquid.

### CROSS-REFERENCE TO RELATED APPLICATION

The present application claims priority to, and the benefit of, U.S. Provisional Application No. 63/160,227, which was filed on Mar. 12, 2021 and is incorporated herein by reference in its entirety.

### FIELD OF THE INVENTION

The present invention relates generally to the field of cleaning devices. More specifically, the present invention relates to a handheld cleaning tool for cleaning vehicles that allows the user to apply soap to the exterior of the vehicle and/or use pressurized water for rinsing the vehicle. The handheld cleaning tool features multiple attachments such as, but not limited to, a rotating brush head to dispense soap solution and a pressure washer attachment to spray clean water. The attachments can be fixed to the tool as per the requirements of the users. Additionally, the tool includes a control switch to operate the tool and allows the users to control the flow of liquid through the tool. The handheld cleaning tool of the present invention eliminates the need to visit car wash stations and allows the users to easily clean their vehicle at home. Accordingly, the present disclosure makes specific reference thereto. Nonetheless, it is to be appreciated that aspects of the present invention are also equally applicable to other like applications, devices, and methods of manufacture.

### BACKGROUND OF THE INVENTION

By way of background, individuals often visit car wash stations, self-serve car washes, and washing centers to get their vehicles cleaned on a regular basis. The vehicles that are used on a daily basis or that are left idle for a long time get dirty and require washing. With the idle vehicles, the dirt may settle on exterior surfaces and make the vehicle unappealing. Further, the vehicles that are used regularly may get dirty due to frequent exposure to dust and dirt from the surroundings and may require regular cleaning as well. Generally, individuals visit a car wash station to get their vehicles cleaned on a regular basis. However, visiting car washing stations is not only a time-consuming process but is expensive as well. Not all individuals can afford the cost of regular cleaning of vehicles at car washing stations.

Some individuals may clean their vehicles, such as cars or trucks, at their homes by themselves. To clean the vehicles, individuals require a container such as a bucket for holding water, a sponge, hose, soap solution and other items generally required for cleaning surfaces. Achieving a thorough cleaning at home can be difficult with a simple bucket, sponge, hose and other items. Also, carrying multiple items to the car washing area from home can be difficult for the users. Using the sponge manually to clean the exterior surface of the vehicle can cause exertion to the users and requires a lot of effort to properly clean a complete outer surface of the vehicle. Additionally, the elderly and individuals with limited dexterity are not comfortable using a bucket, sponge and more for cleaning vehicles. Such individuals may be reluctant to wash their cars themselves, and may leave their cars dirty. Leaving the car dirty can appear unprofessional depending on one's job. Currently, individuals desire to have an easy, as well as affordable method for thoroughly cleaning the exterior of the vehicles without visiting car wash stations.

Therefore, there exists a long felt need in the art for a handheld cleaning tool that allows the users to easily clean the exterior surfaces of the vehicle. There is also a long felt need in the art for a device that allows the users to clean vehicles at home, and eliminates the need to visit vehicle washing stations. Additionally, there is a long felt need in the art for a vehicle cleaning device that is affordable for all individuals. Moreover, there is a long felt need in the art for a vehicle cleaning device that allows the users to quickly clean the outer surface of the vehicles. Further, there is a long felt need in the art for a vehicle cleaning device that can be comfortably used by the elderly and individuals with limited dexterity. Furthermore, there is a long felt need in the art for a handheld vehicle cleaning tool that does not require the users to carry multiple items such as a bucket, soap solution, sponge and more. Finally, there is a long felt need in the art for a vehicle cleaning device that saves time and money of the users, is portable and can be easily carried to the desired location.

The subject matter disclosed and claimed herein, in one embodiment thereof, comprises a handheld washing device. The washing device applies a soapy solution to a surface and pressurized water for rinsing. More specifically, the washing device includes: an elongated shaft; a handle for gripping the washing device; the elongated shaft has an internal conduit; a hose connector at the proximal end of the elongated shaft for receiving a hose; an attachment connector at distal end of the elongated shaft for connecting a water nozzle or a soap dispensing attachment; the conduit carries the fluid received from the hose and is dispensed through a connector attached to the attachment connector; and, a motor to pressurize the fluid received from the hose wherein the motor is connected to a built-in battery.

In this manner, the novel handheld vehicle washing device of the present invention accomplishes all of the forgoing objectives, and provides a relatively convenient, quick and cost-effective solution to clean the exterior of vehicles without visiting car washing stations. The handheld vehicle washing device of the present invention is also user-friendly, as it does not require the users to carry multiple cleaning tools such as a bucket, sponge, soap solution and more, and allows the users to clean vehicles using a single cleaning device. Additionally, the handheld vehicle washing device can be conveniently used by the elderly and/or individuals with limited dexterity, and ensures the vehicles look appealing all the time.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a handheld washing device. The washing device is configured to apply soap to a surface and pressurized water for rinsing. The washing device further comprises: an elongated shaft; a handle for gripping the washing device; the elongated shaft has an internal conduit; a hose connector at a proximal end of the elongated shaft for receiving a hose; an attachment connector at a distal end of the elongated shaft for connecting a water nozzle or a soap dispensing attachment; the conduit carries the fluid received from the hose and is dispensed through a connector attached to the attachment connector; and, a motor to pressurize the fluid received from the hose wherein the motor is connected to a built-in battery. A trigger button on the handle operates the device and runs the motor to discharge the fluid in the form of a pressurized spray.

In a further embodiment of the present invention, a portable vehicle washing device is disclosed. The portable vehicle washing device includes: an elongated shaft having an internal hollow conduit or channel for transporting fluid within the device for dispensing; a hose connector disposed on one end of the elongated shaft; the hose connector being configured to receive water or a soapy solution under pressure from a hose; a nozzle connector positioned at another end of the elongated shaft to receive a nozzle for dispensing water or a soapy solution wherein the dispensing water or soapy solution travels through the hollow conduit from the hose connector to the nozzle; a handle for gripping the device; a rechargeable battery disposed within the handle; and, a motor disposed within the handle or the elongated shaft configured to apply force to create pressurized water or a soapy solution for dispensing. The handle has a plurality of control buttons to selectively control the pressure of the fluid and a trigger for turning on and off the washing device.

In a further embodiment of the present invention, the hose connector has a blocking pin to block water inlet from the connected hose. When a trigger positioned on the handle of the washing device is pulled by a user, the blocking pin is moved enabling water or a soapy solution from the hose to enter the hollow pipe for dispensing through the attached nozzles.

In yet a further embodiment of the present invention, the portable washing device for cleaning a surface or a vehicle is disclosed. The portable washing device includes: a detergent reservoir configured to provide detergent in solid or liquid form; an elongated shaft having an internal conduit; a hose connector disposed on one end of the elongated shaft; the hose connector being configured to receive pressurized water from a hose; a water nozzle or a rotating soap dispenser positioned at another end of the elongated shaft; and, a motor mixes the detergent from the detergent reservoir and the pressurized water to form a soapy solution for dispensing through the rotating soap dispenser. The inlet of the detergent reservoir is closed when pressurized water is dispensed using the water nozzle from the washing device.

In yet a further embodiment of the present invention, the water nozzle and the rotating soap dispenser are interchangeable as per the preferences of a user. The trigger starts the flow of fluid in the conduit and a plurality of control buttons allows the pressure of the flow to increase or decrease. The hose connector is an inlet of fluid for the device and the dispensing attachments are an outlet for the fluid.

In yet a further embodiment of the present invention, a method of applying a soap solution and rinsing a surface is disclosed. The soap solution is applied using a portable washing device with a rotating soap dispenser dispensing the soapy solution, next, interchanging the rotating soap dispenser with a water nozzle, and finally, dispensing pressurized water for rinsing the surface to attain effective cleaning. The soapy solution and the pressurized water are received through a hose connected to a hose connector of the portable washing device.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a handheld washing device of the present invention in accordance with the disclosed architecture;

FIG. 2 illustrates a perspective view of one potential embodiment of a handle of the handheld washing device of the present invention in accordance with the disclosed architecture, wherein the handle comprises control buttons to change the flow of the dispensed liquid;

FIG. 3 illustrates a perspective view of one potential embodiment of portable washing device attachments for dispensing water and soap from the handheld washing device in accordance with the disclosed architecture;

FIG. 4 illustrates a perspective view showing a user cleaning a vehicle using a water spray from one potential embodiment of the handheld washing device of the present invention in accordance with the disclosed architecture;

FIG. 5 illustrates a perspective view showing one potential embodiment of the handheld washing device of the present invention dispensing a soapy solution on a surface in accordance with the disclosed architecture; and

FIG. 6 illustrates a close-up perspective view of the hose attachment of one potential embodiment of the handheld washing device of the present invention in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long felt need in the art for a handheld cleaning tool that allows the users to easily clean the exterior surface of the vehicles. There is also a long felt need in the art for a device that allows the users to clean vehicles at home and eliminates the need to visit vehicle washing stations. Additionally, there is a long felt need in the art for a vehicle cleaning device that is affordable by all individuals. Moreover, there is a long felt need in the art for a vehicle cleaning device that allows the users to quickly clean the outer surface of the vehicles. Further, there is a long felt need in the art for a vehicle cleaning device that can be comfortably used by the elderly and individuals with limited dexterity. Furthermore, there is a long felt need in the art for a handheld vehicle cleaning tool that does not require the users to carry multiple items such as a bucket, soap solution, sponge, and more. Finally, there is a long felt need in the art for a vehicle cleaning device that saves the time and money of the users, is portable and can be easily carried to the desired location.

The present invention, in one exemplary embodiment, discloses a novel vehicle washing device. The portable vehicle washing device includes: an elongated shaft having an internal hollow conduit or channel for transporting fluid within the device for dispensing; a hose connector disposed on one end of the elongated shaft; the hose connector being configured to receive water or a soapy solution under pressure from a hose; a nozzle connector positioned at another end of the elongated shaft to receive a nozzle for dispensing water or a soapy solution wherein the dispensing water or soapy solution travels through the hollow conduit from the hose connector to the nozzle; a handle for gripping the device; a rechargeable battery disposed within the handle; and, a motor disposed within the handle or the elongated shaft configured to apply force to create pressurized water or a soapy solution for dispensing. The handle has a plurality of control buttons to selectively control the pressure of the fluid and a trigger for turning on and off the washing device.

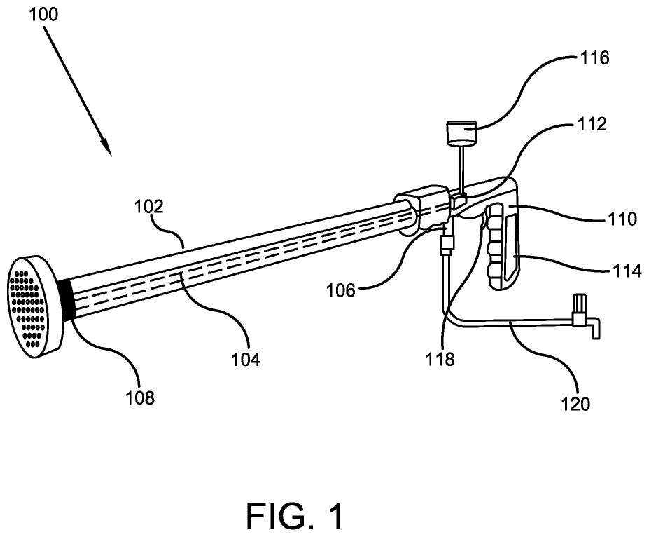

Referring initially to the drawings, FIG. 1 illustrates a perspective view of one potential embodiment of a handheld vehicle washing device of the present invention in accordance with the disclosed architecture. The handheld vehicle washing device 100 is configured to be used as a personal device for washing vehicle exterior at home and does not require any external power supply for operation. The washing device 100 is ideal for both commercial and personal vehicles and can be used for cars, buses, trucks, and other types of vehicles.

The portable washing device 100 is commercially available with two attachments that are replaceable and removably attached to the washing device 100. The attachments are used for dispensing a soapy solution and a water jet respectively. The washing device 100 has an elongated shaft 102 containing a hollow tube or channel 104 that acts as a conduit for the water or soap solution for dispensing. The elongated shaft 102 runs from a hose connector 106 at one end to an attachment connector 108 positioned at another end of the washing device 100. The hollow tube 104 is internal to the elongated shaft 102 and is not visible to a user. In one potential embodiment, the hose connector 106 can be connected to a water hose 120 that carries a supply of pressurized water from a domestic water source. However, a hose connection without supply of pressurized water is also contemplated.

A proximal end of the washing device 100 has a handle 110 for gripping and manipulation of the washing device 100 during use. The device 100 contains a motor 112 to generate high speed jets of water by providing momentum to water received from the hose connector 106. The motor 112 is used particularly in cases where the inlet supply does not have pressurized water. The hose connector 106 forms the water inlet for the washing device 100 and the received water through the hose 120 is sprayed in the form of jets using the motor 112. The motor 112 receives electrical power from a built-in battery 114 of the washing device 100. The battery 114 is built-in within the handle 110 and is coupled to the motor 112. In one potential embodiment, the battery 114 can be a 20V Lithium-Ion battery which can be charged using an accompanied charger.

In the present embodiment, a detergent reservoir 116 can be selectively detached and attached to the device 100, thereby enabling the device 100 to dispense a soapy foam for washing a vehicle. The detergent reservoir 116 can be secured to a portion of the device 100 and connected to the hollow tube or conduit 104. The detergent reservoir 116 is capable of receiving any number of commercially available cleaning solutions and can act to store and mix the cleaning solutions with water supplied through the hose attachment 106. The device 100 can be turned ON using a trigger 118 present on the exterior surface of the handle 110 to start dispensing the water and/or soapy solution. The handle 110 has an ergonomic grip enabling a user to operate the device 100 easily and conveniently.

The portable vehicle washing device 100 of the present invention provides a water jet with pressure at a nozzle in the range generally from about 30 bar to about 170 bar. The device 100 provides portable cleaning from any water source such as, for example, hose-to-bucket, hose-to-lake and hose-to-faucet, and can provide power for a water intake of up to 0.7 GPM (gallons per minute). The device 100 can have a variable valve connected to the handle enabling selective pressure change, thus making the device 100 suitable for a variety of vehicles. The device 100 directs a jet of water and the soapy solution against exterior surfaces of vehicles to clean, descale, degrease, and clean the surfaces.

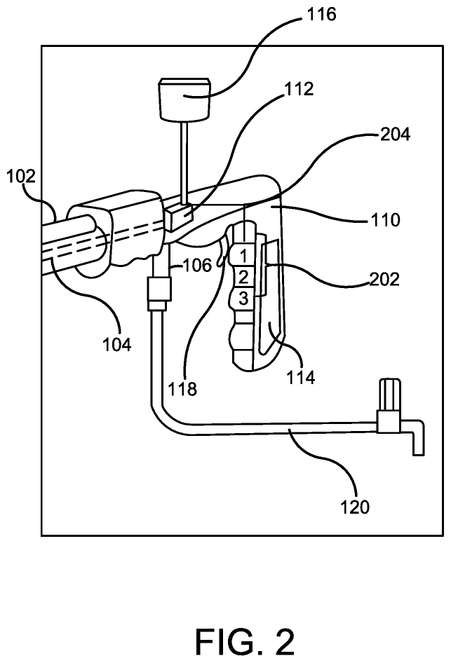

FIG. 2 illustrates a perspective view showing the handle of the handheld washing device of the present invention having control buttons to selectively change the flow or momentum of the dispensed liquid in accordance with the disclosed architecture. In one potential embodiment of the present invention, the handle 110 includes a plurality of control buttons 202 for controlling the pressure of the liquid dispensed from the device 100. The plurality of control buttons 202 are used for selectively setting a particular level of pressure with which the liquid is dispensed. The control buttons 202 are coupled to the internal motor 112 through the wired mechanism 204 and are configured to control the rotation of the motor 112. Control buttons 202 allow a user to use the device for multiple uses such as cleaning a vehicle including a car or a truck. Additionally, the device 100 can be used for cleaning any surface.

It should be appreciated that the device 100 obviates the need for any additional electrical power for operation and all the components receive power from the built-in battery 114. The battery 114 is coupled to all the components through a wired circuit (not shown) and any conventional wired circuit in the form of a printed circuit board or chip can be used in the device 100. A separate control button can also be used with the handle to activate the detergent dispenser 116. Once the control button is activated, the device 100 along with dispenser 116 can provide a soapy solution even in cases where the hose 120 does not provide a soapy solution.

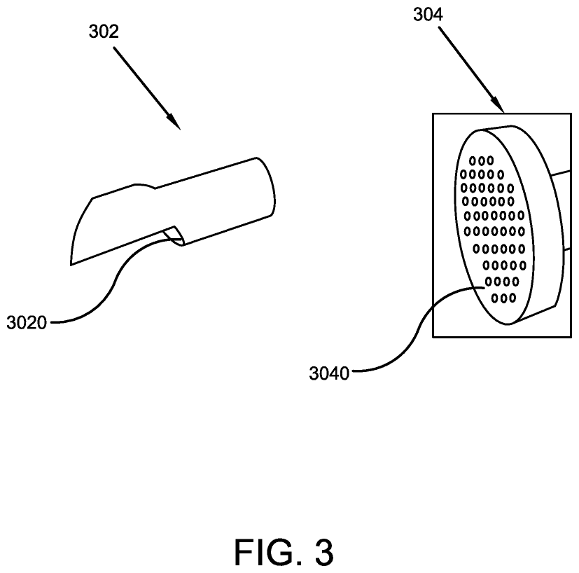

FIG. 3 illustrates a perspective view showing the portable washing device attachments for dispensing water and soap in accordance with the disclosed architecture. A water nozzle 302 can be configured to dispense pressurized water for cleaning a surface and can be easily screwed to the attachment connector at the distal end of the device 100. The water nozzle 302 can include an opening 3020 that dispenses the water in the form of a spray to provide effective cleaning of a surface. A soap dispenser 304 can be mounted at a distal end of the shaft 102 and can include a rotating brush head powered by the motor 112 and can include a plurality of openings 3040 that dispense a soapy foam for washing. The soap dispenser 304 and the water nozzle 302 can be used as per the preferences of a user.

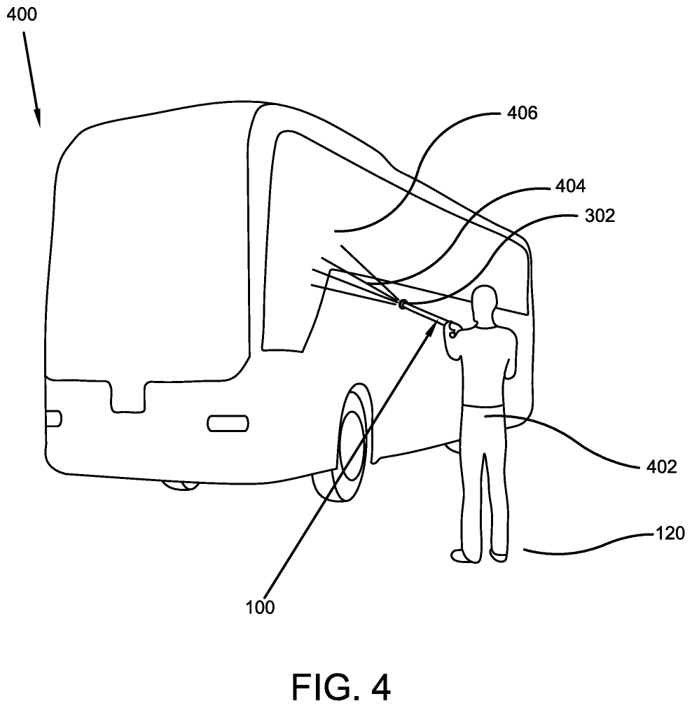

FIG. 4 illustrates a perspective view showing a user cleaning a vehicle using a water spray from the vehicle cleaning device of the present invention in accordance with the disclosed architecture. A user 402 can use the vehicle cleaning device 100 of the present invention to clean the exterior surface 406 of a vehicle 400, such as a bus or any other automobile. The device 100 is connected to a hose 120 for supplying water from a water source. The water nozzle attachment 302 is connected at the head of the device 100 and the cleaning device is turned ON using the trigger present on the handle of the device 100, thereby enabling the motor to operate and dispense a pressurized water spray 404 towards the vehicle 400 to clean the exterior surface 406.

The pressure of the water spray 404 can be customized based on the type of the vehicle to be cleaned. Water pressure level control buttons can be used to customize the water pressure in the present embodiment. The cleaning device 100 can be used for cleaning built-up dirt and mold on wood, aluminum and vinyl shutters, concrete sidewalks, wood decks, brick, stone, rock, cars, trucks, campers, boats and much more. The device 100 is sturdy, lightweight, compact, easy to use, anticorrosive and durable and, therefore, able to withstand pressure and wear over time.

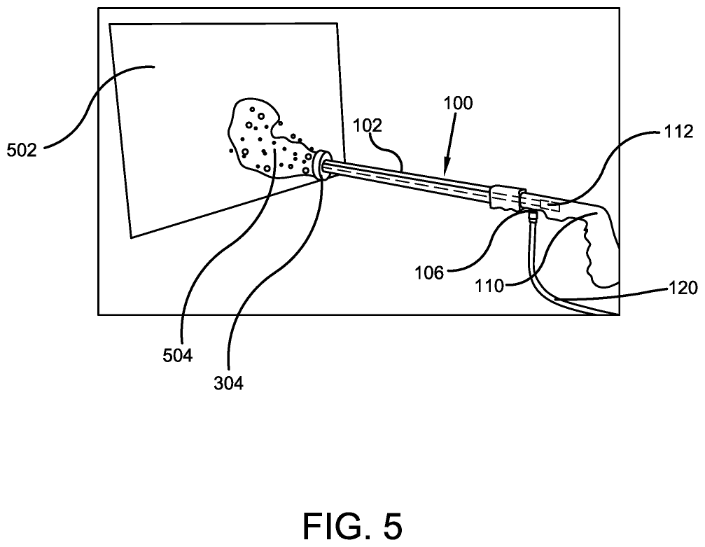

FIG. 5 illustrates a perspective view showing the handheld cleaning solution device of the present invention dispensing a soapy solution on a surface in accordance with the disclosed architecture. In the present embodiment, the cleaning device 100 includes the attached soap dispenser attachment 304 at the distal end. The soap dispenser attachment 304 is powered by the built-in motor 112 of the device 100 and a pressurized soap solution 504 is dispensed against a surface 502.

In the present embodiment, a soap solution is directly fed into the device 100 using a hose 120 connected to the hose connector 106. The inlet soap solution is pressurized by the motor 112 to provide a strong pressurized soapy spray 504. It is an objective of the current invention to provide a multi-purpose handheld washing device 100, that minimizes the wasting of fresh water and soapy water. Further, a single conduit can be used for a soapy water line and a freshwater line, thus making the device compact and sleek.

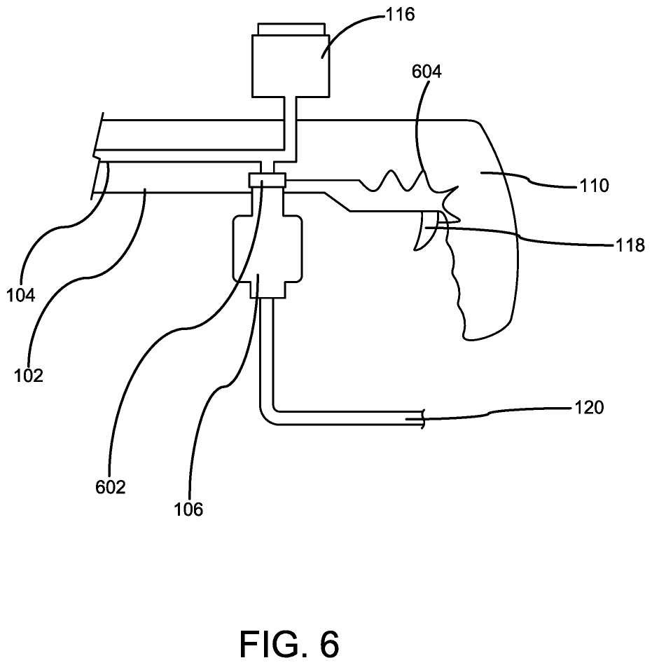

FIG. 6 illustrates an enlarged view of the hose attachment of one potential embodiment of the handheld washing device of the present invention in accordance with the disclosed architecture. The hose connector 106 can be configured to receive a hose or pipe 120 that carries water or any soapy solution which can be dispensed through the spray nozzle or the soap dispenser. A blocking pin 602 is present on the top of the hose connector 106 to block the fluid carried by the hose 120 from entering the conduit or hollow pipe 104. When the trigger 118 of the handle 100 is pulled by a user of the device 100 for dispensing water or any soapy solution, the blocking pin 602 coupled to the trigger 118 via a spring 604, is pulled away from the top of the hose connector 106, thereby enabling fluid to enter the hollow pipe 104. Similarly, when the cleaning is finished, the trigger 118 can be released whereby the blocking pin 602 blocks the fluid. In this way, the device 100 allows safe and efficient use for cleaning any surface wherein the operation is controlled by an operator of the device 100.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “handheld vehicle washing device”, “handheld washing device”, “washing device”, “portable washing device”, “multi-purpose handheld washing device”, and “device”, are interchangeable and refer to the handheld vehicle washing device 100 of the present invention.

Notwithstanding the forgoing, the handheld vehicle washing device 100 the present invention can be of any suitable size and configuration as is known in the art without affecting the overall concept of the invention, provided that it accomplishes the above-stated objectives. One of ordinary skill in the art will appreciate that the size, configuration, and material of the handheld vehicle washing device 100 as shown in the FIGS. are for illustrative purposes only, and that many other sizes and shapes of the handheld vehicle washing device 100 are well within the scope of the present disclosure. Although the dimensions of the handheld vehicle washing device 100 are important design parameters for user convenience, the handheld vehicle washing device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A cleaning device that is both handheld and portable, the cleaning device comprising:
a handle;
an elongated shaft connected to said handle, wherein said elongated shaft comprises an internal hollow conduit therethrough;
a hose connection providing a water inlet at a proximal end of said internal hollow conduit;
a nozzle providing an exit at a distal end of said internal hollow conduit;
a motor for generating a pressure to a quantity of water received from said water inlet;
a battery for supplying power to said motor; and
a trigger on said handle for actuating a blocking pin for selectively blocking and releasing the quantity of water through said internal hollow conduit.

2. The cleaning device of claim 1 further comprising a reservoir for dispensing a detergent though said internal hollow conduit.

3. The cleaning device of claim 2, wherein said reservoir is a rotating reservoir.

4. The cleaning device of claim 2, wherein said reservoir is selectively attachable to said elongated shaft.

5. The cleaning device of claim 4, wherein said pressure at said nozzle is generally from about 30 bar to about 170 bar.

6. The cleaning device of claim 5, wherein said motor draws the quantity of water from a source into said water inlet.

7. The cleaning device of claim 6, wherein said water draw is up to about 0.7 gallons per minute.

8. The cleaning device of claim 7, wherein said source is selected from a group consisting of a bucket, a lake and a faucet.

9. The cleaning device of claim 6, wherein said handle includes a plurality of control buttons for selectively changing said pressure at said nozzle.

10. The cleaning device of claim 9, wherein said nozzle is a rotating brush head.

11. A cleaning device comprising:
a handle;
an elongated shaft connected to the handle, wherein said elongated shaft comprises an internal hollow conduit therethrough;
a hose connection providing a water inlet at a proximal end of said internal hollow conduit;
a nozzle providing an exit at a distal end of said internal hollow conduit;
a motor for generating a momentum to a quantity of water received from said water inlet;
a battery for supplying a power to said motor;
a trigger for actuating a blocking pin for selectively blocking and releasing the quantity of water through said internal hollow conduit; and
a detergent reservoir for dispensing a detergent through said internal hollow conduit, wherein said detergent reservoir is a rotating reservoir.

12. The cleaning device of claim 11, wherein said detergent reservoir is selectively attachable to said elongated shaft.

13. The cleaning device of claim 12, wherein said momentum produces a water pressure at said nozzle generally from about 30 bar to about 170 bar.

14. The cleaning device of claim 13, wherein said motor draws the quantity of water from a source into said water inlet.

15. The cleaning device of claim 14, wherein said water draw is up to about 0.7 gallons per minute.

16. The cleaning device of claim 15, wherein said source is selected from a group consisting of a bucket, a lake and a faucet.

17. The cleaning device of claim 16, wherein said handle comprises a plurality of control buttons for selectively changing said water pressure at said nozzle.

18. The cleaning device of claim 17, wherein said nozzle is a rotating brush head.

19. A handheld portable cleaning device comprising:
a handle;
an elongated shaft attached to the handle and comprising an internal hollow conduit therethrough;
a hose connection providing a water inlet at a proximal end of said internal hollow conduit;
a nozzle providing an exit at a distal end of said internal hollow conduit;
a motor for generating a momentum to a quantity of water received from said water inlet, wherein said motor draws the quantity of water from a source into said water inlet, and further wherein said water draw is up to about 0.7 gallons per minute;
a battery for supplying power to said motor, wherein said momentum produces a water pressure at said nozzle generally from about 30 bar to about 170 bar;
a trigger for actuating a blocking pin for selectively blocking and releasing the quantity of water through said internal hollow conduit; and
a detergent reservoir for dispensing a detergent through said internal hollow conduit.

20. The handheld portable cleaning device of claim 19, wherein said handle comprises a control button for selectively changing said water pressure at said nozzle.
